(19) United States
(12) Patent Application Publication
(10) Pub. No.: US 2004/0171413 A1
(43) Pub. Date: Sep. 2, 2004

(54) Word game and apparatus for playing same

(76) Inventor: Rodolphe Charpentier, Quebec (CA)

Correspondence Address: SALIWANCHIK LLOYD & SALIWANCHIK, A PROFESSIONAL ASSOCIATION, 2421 N.W. 41ST STREET, SUITE A-1, GAINESVILLE, FL, 32606-6669, US

(21) Appl. No.: 10/432,135

(22) PCT Filed: Nov. 16, 2001
(86) PCT No.: PCT/CA01/01610

(30) Foreign Application Priority Data
Nov. 16, 2000 (CA) 2,326,242

(51) Int. Cl. G06F 17/00; G06F 19/00

(52) U.S. Cl. 463/9

(57) ABSTRACT

The present invention provides a method and apparatus for playing a word game incorporating word formation through the arrangement of playing units, wherein a playing unit is associated with a letter of an alphabet. A player can form new words by arranging playing units contained in an exposed collection or by stealing words which have previously been formed by another player. A player can steal a performed word by arranging a group of playing units into a new word, wherein the group comprises the playing units of the pre-formed word and at least one playing unit from the exposed collection. Included within the letters identified on the playing units may be a joker insignia, wherein a joker insignia can represent any letter value desired and may be changed during play of the game. A player attempts to form and maintain possession of a predetermined number of words in order to win the game.

### RESERVATION OF COPYRIGHT

A portion of the disclosure of this patent document contains material to which a claim of copyright protection is made. The owner has no objection to the facsimile reproduction by anyone of the patent document or the patent disclosure as it appears in the Patent and Trademark Office patent file or records, but reserves all other rights whatsoever.

### FIELD OF THE INVENTION

The present invention pertains to the field of entertainment and more particularly to games involving the formation of words and apparatus for playing the same.

### BACKGROUND

Numerous playing games are readily available which utilize the skill and imagination of players. More recently, word games have become popular utilizing the word skills of players. Such games are both challenging, enjoyable, and at the same time, have an educational value since they require the imagination of the player, utilizing their word knowledge.

At the present time, one of the more common word building games is SCRABBLE™, in which tiles bearing letters are placed on a board to form a crossword type of arrangement. The scoring of this game depends partially on arbitrary values given to the letters themselves and partially upon their actual location on the board. A restriction in SCRABBLE™ is that a player is required, when making a crossword, to use one letter of a word upon the board, or a word on the board as a root for the new word. Furthermore, these words, once placed on the board are effectively static, and thus cannot be altered.

U.S. Pat. No. 4,690,410 describes a word forming game, in which a player has the option to use any of the letter tiles that have been put in play. Letter tiles contained either in previously formed words or exposed tiles within the tile pool can be used to create new words. The cannibalizing of another players word is only possible if an additional letter is added to the letters of the word and this group of letters is then rearranged to form a new word. Upon formation of a word the player places the letter tiles forming said word in front of their position. The scoring of this game is based on the number of tiles, which have been formed into words, that a player has in front of themselves plus bonus points, if any, signified on these letter tiles. Furthermore, for this game, the total number of letter tiles is not critical but the frequency of each letter is based on the known frequency tables of the occurrence of a particular letter in the language in which the game is to be played.

There are a number of electronic word games which have been developed over the years. For example U.S. Pat. No. 5,921,864 describes an electronic word puzzle game where a player attempts to solve a hidden phrase, quote, name or other word group through the selection of letters. The game adjusts the score resulting from the solution of the hidden phrase depending on the required number of exposed letters to be indicated in order to solve the hidden phrase. The word puzzle apparatus comprises: a processor and a memory connected to the processor storing a program to control the operation of the processor, wherein the processor is operative with the program in the memory to initialize score data representing a score; determine a puzzle phrase, the puzzle phrase comprising a plurality of characters, each of the plurality of characters being selected from the group consisting of letters, spaces and punctuation marks; display a plurality of display areas, each display area corresponding to one of the plurality of characters of the puzzle phrase; receive a player selection, the player selection being selected from a plurality of player selectable characters consisting of letters, spaces and punctuation marks; update the score data, thereby decreasing the score based on an elapsed time; compare the player selection to at least one character of the puzzle phrase to determine whether the player selection matches any of the at least one character of the puzzle phrase; and display each character of the puzzle phrase determined to match the player selection.

U.S. Pat. No. 4,438,932 details an apparatus for an electronic word game in which is displayed a word selected by the actuation of letter keys by one player. Also displayed is a pictorial illustration of the anatomy of a person on gallows. The selected word is blanked out so as not to be observed by another player, although the other player can observe the number of letters in the selected word. The other player selects successively letters to arrive at the spelling of the selected word. Letter keys are actuated in accordance with the letters selected by the other player. Each incorrect selection of a letter by the other player results in a different part of the anatomy being sequentially lighted, i.e. neck, arms, torso and legs. Should the entire anatomy be lighted, the other player has lost the game. Should all the letters of the selected word be correctly selected, the other player has won the game.

In word forming games, the quantity of each vowel or consonant in the pool of letter tiles usually reflects the relative frequency of use of each of the letters as they appear in the words of the language. For instance, it is well known that the letter “E” is the most frequently used letter in words of the English language and, therefore, the most frequently occurring letter tile in English language word forming games. However, the frequency of letter usage may vary depending on the source of words. For instance, letter usage may vary between literary text and telegrams, children and adults, or printed text and conversation. Further, letter usage frequency may vary within a single source. As an example, letter usage in conversation may vary dramatically between educated and uneducated adults. Also, usage of technical words, frequently used words, lengthy words, short words or any number of other factors may cause the letter usage frequency to vary. These and other factors, which are used by game developers in determining the letter frequency, can significantly affect the availability of letters in the letter tile pool, which as a consequence, may directly impact a player's ability to form a word during the game.

A hypothetical word game, which bases the letter selection solely upon technical words, may prove too difficult for persons having little or no familiarity with these technical words. Conversely, a word game which has a letter selection based on commonly used words, and more particularly, words used commonly in conversation, may provide more word-forming opportunities for persons without a sophisticated technical vocabulary. Thus adjusting the letter frequency within a word forming game, can dramatically change the dynamics of a particular game.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a word game and apparatus for playing same. In accordance with an aspect of the present invention, there is provided an electronic word game apparatus comprising: a memory means comprising an electronic dictionary compatible with a desired language, an electronic version of a set of rules for playing the word game and areas for temporary storage of information during play of the word game; a computing means for performing tasks, wherein said tasks comprise selecting, randomly, one or more letters, comparing words formed during play of the word game, with words contained in the electronic dictionary providing a means for verification of formed words; a player input means for enabling a player to interact with the computing means during play of the word game; and an electronic display means comprising a plurality of areas, wherein said areas display game information to a player; wherein said computing means, memory means, player input means and electronic display means are in electronic communication with one another and serve for playing said word game according to the set of rules comprising: selecting, randomly, a predetermined number of starting letters selected from a pool of letters and exposing said starting letters to form an exposed collection, wherein said pool of letters comprises letters of an alphabet and at least one joker letter, wherein said joker letter can be assigned a value of any letter within the alphabet and wherein said value of the joker letter can be amended during play; and arranging a new word having an assigned minimum number of letters by: using letters contained within said exposed collection or stealing a word previously arranged by another player, wherein the new word is formed by the arrangement of a group of letters comprising the letters of the stolen word and at least one letter from the exposed collection, wherein said arranging is performed by an active player and wherein upon formation of the new word the active player is assigned ownership of the new word and wherein upon the occurrence of a predetermined event a subsequent player becomes the active player; and continuing with step (2) until a player has been assigned ownership of a pre-selected number of formed words or the pool of letters is exhausted or no further words are capable of being formed; and wherein a letter randomly selected from the pool of letters is exposed and added to the exposed collection prior to the arranging of a new word by the active player.

In accordance with another aspect of the invention, there is provided a word game comprising the steps of: providing a game apparatus to a group of one or more players; selecting, randomly, a predetermined number of starting letters selected from a pool of letters and exposing said starting letters to form an exposed collection, wherein said pool of letters comprises letters of an alphabet and at least one joker letter, wherein said joker letter can be assigned a value of any letter within the alphabet and wherein said value of the joker letter can be amended during play; determining, randomly, which player is to be designated an active player; selecting, randomly, a particular number of letters from the pool of letters, subsequently exposing and adding these letters to said exposed collection; arranging a new word having an assigned minimum number of letters wherein said letters are selected from said exposed collection and wherein said arranging is performed by the active player, wherein upon formation of a new word the active player is assigned ownership of the new word; continuing with step (e) until a predetermined event, wherein upon the occurrence of said predetermined event a subsequent player becomes the active player: arranging a further new word having an assigned minimum number of letters by: using letters contained within said exposed collection or stealing a word previously arranged by another player, wherein the new word is formed by the arrangement of a group of letters comprising the letters of the stolen word and at least one letter from the exposed collection; wherein said arranging is performed by the active player and wherein upon formation of the new word the active player is assigned ownership of the new word and wherein upon the occurrence of the predetermined event a subsequent player becomes the active player; continuing with the previous step until a player has been assigned ownership of a pre-selected number of formed words or said pool of letters is exhausted or no further words are capable of being formed; determining a winner by evaluating which player is assigned ownership of the largest number of words; wherein a letter randomly selected from the pool of letters is exposed and added to the exposed collection prior to the arranging of a new word by the active player.

### BRIEF DESCRIPTION OF THE FIGURES

FIG. 1 is an overall schematic view of various parts of one embodiment of the present invention.

FIG. 2 is a schematic view of a further embodiment of the present invention.

FIG. 3 is a schematic of basic hardware components of the embodiment according to FIG. 2.

FIG. 4 is a schematic view of an initial setup of the present invention according the embodiment illustrated in FIG. 1.

FIG. 5 is a schematic view of selection of the first active player according the embodiment illustrated in FIG. 1.

FIG. 6 is a schematic view of selection of the concealed playing tile according the embodiment illustrated in FIG. 1.

FIG. 7 is a schematic view of formation of a word using the exposed collection according the embodiment illustrated in FIG. 1.

FIG. 8 is a schematic view of stealing of an opponent's word according the embodiment illustrated in FIG. 1.

FIG. 9 is a schematic view of a possible use of the joker tile according the embodiment illustrated in FIG. 1.

FIG. 10 is a schematic view of a sequence of events for the formation of a word according to the embodiment illustrated in FIG. 2.

FIG. 11 is a schematic view of a sequence of events for the formation of a word through the stealing of a preformed word according to the embodiment illustrated in FIG. 2.

FIG. 12 is a schematic view of a sequence of events for one method for the replacement of a joker letter according to the embodiment illustrated in FIG. 2.

FIG. 13 is a schematic view of a sequence of events for a second method for the replacement of a joker letter according to the embodiment illustrated in FIG. 2.

FIG. 14 is a schematic view of a sequence of events for the stealing of a preformed word containing a joker letter according to the embodiment illustrated in FIG. 2.

### DETAILED DESCRIPTION OF THE INVENTION

Definitions

The term “playing unit” is used to describe a means of displaying a letter in order that a word game may be played. A playing unit can be, for example, a tile or a letter on an electronic display. In addition, a playing unit may be embodied in the form of a three dimensional object for example a ball, or a cube.

The term “playing surface” is used to describe any means upon which the game may be played and displayed, for example, an electronic medium which may include a CRT display, LCD display, a LED display, plasma display, LCD or DLP projection display; or a board medium which may be formed from paper, cloth, foam or rubber or some combination thereof. The playing surface may be associated with a large or a small computing device or may be associated with a large or small board medium. In an electronic form, the playing surface may be incorporated into a hand held device or may be incorporated into a large system enabling a plurality of players to participate in the game while referencing a communal large screen for game updates.

The term “playing procedure” is used to describe a set of rules according to which a game is to be played. The playing procedure establishes the parameters by which for example, a player wins a game or performs particular activities during play of the game and may establish parameters for the validity of particular word formations.

The term “letter” is used to describe any insignia which may be interpreted as a character in an alphabet or may be considered as a “wild” or “joker” insignia. This insignia of a character may be for example a printed letter or a Braille representation of a letter.

The phrase “exposed collection” is used to describe the pool of playing units that are visible to all of the players and can be used to form new words.

The term “player” is used to describe an individual or a group of individuals that are acting as one, who are participating in the game.

The phrase “active player” is used to describe the player that is currently allowed to form words.

Unless defined otherwise, all technical and scientific terms used herein have the same meaning as commonly understood by one of ordinary skill in the art to which this invention belongs.

The present invention provides a method and apparatus for playing a word game incorporating word formation through the arrangement of playing units, wherein a playing unit is associated with a letter of an alphabet. A player can form new words by arranging playing units contained in an exposed collection or by stealing words which have previously been formed by another player. A player can steal a preformed word by arranging a group of playing units into a new word, wherein the group comprises the playing units of the pre-formed word and at least one playing unit from the exposed collection. Included within the letters identified on the playing units may be a joker insignia, wherein a joker insignia can represent any letter value desired and may be changed during play of the game. A player attempts to form and maintain possession of a predetermined number of words in order to win the game.

In one embodiment of the present invention, the object of the game is to be the first to form and to be assigned ownership of a predetermined number of words, for example 5, 6 or 7. Preferably the words are constructed using words previously formed by another player, if there are any, which are augmented with at least one playing unit to form a new word. Procedure enables the active player to be assigned possession of the new word, which is formed from a word previously in possession of an opponent. At any point in the game, the active player may use any combination of playing units within the exposed collection or a set of playing units contained within a pre-formed word to form a new word.

Each embodiment of the present invention comprises a plurality of playing units, a playing surface wherein the use of the playing units and the playing surface is defined by a playing procedure. A game played according to the method of the present invention may be embodied as a board game type configuration comprising a playing surface, which may be a game board and a collection of playing units which may be tiles having insignias imprinted thereon. In addition, the game may be embodied as an electronic type game, wherein both the playing units and the playing surface may be envisioned as electronic elements. For each of these embodiments, the playing procedure is associated with these elements thus providing a means for playing the word game of the present invention. In one embodiment the playing procedure may be provided in the form of printed rules or in an electronic format.

A board game apparatus which is suitable for playing a word game as described herein may acquire various forms. In one embodiment, the board game apparatus may resemble a standard sized board game. In addition, a board game apparatus may be embodied as a travel size game, wherein said apparatus would be of a size providing ease of transport. In this embodiment the playing units and the playing surface may be designed such that these components are temporarily connectable, for example using magnetism or a hook and eye type of connection means, thus providing a means for playing said word game during movement.

An electronic game apparatus which is suitable for playing a word game as described herein may acquire various forms. In one embodiment, the electronic game apparatus may be solely software which may be integrated into a standard computing device, for example a personal computer or a personal digital assistant or a cellular phone, wherein said software will define parameters for keys associated with said computing devices (for example, ENTER, F10, etc) providing a means for the player to play the game. In a further embodiment, the electronic game apparatus may be a combination of hardware and software which is dedicated to the word game of the present invention. For example, a dedicated electronic game apparatus may be in the form of a handheld device or a larger machine which may be used in casino or gambling type venues.

In one embodiment, the electronic game apparatus may be designed such that a single player may play the game against an electronic competitor, said electronic game apparatus having associated with it the appropriate logic software and hardware for playing the game. In addition, a collection of players may compete against one another using an electronic game apparatus according to the present invention.

In one embodiment, the present invention can be used as an educational tool, possibly enabling players to expand and develop their vocabulary and improve their spelling. In addition, the present invention may be used as a tool for aiding students developing language skills, for example second and third language education.

In one embodiment of the present invention, the game apparatus can be specifically designed to be compatible with a particular language and the appropriate alphabet for this language. For example words contained with in an electronic dictionary will be dependent on the language. The particular language can be selected from the group comprising: English, French, Spanish, Portuguese, German, Chinese, Japanese, Arabic and Greek. However, according to the present invention, the word game can be played in any language. In a further embodiment of the present invention the pool of playing units which are used to play the game may have a letter ratio which is consistent with the ratio of the use of each particular letter with respect to the particular language in which the game is played. For example, in the English language the letter “E” is the most commonly used letter and therefore may be the most common letter in the pool of playing units.

Board Game Apparatus

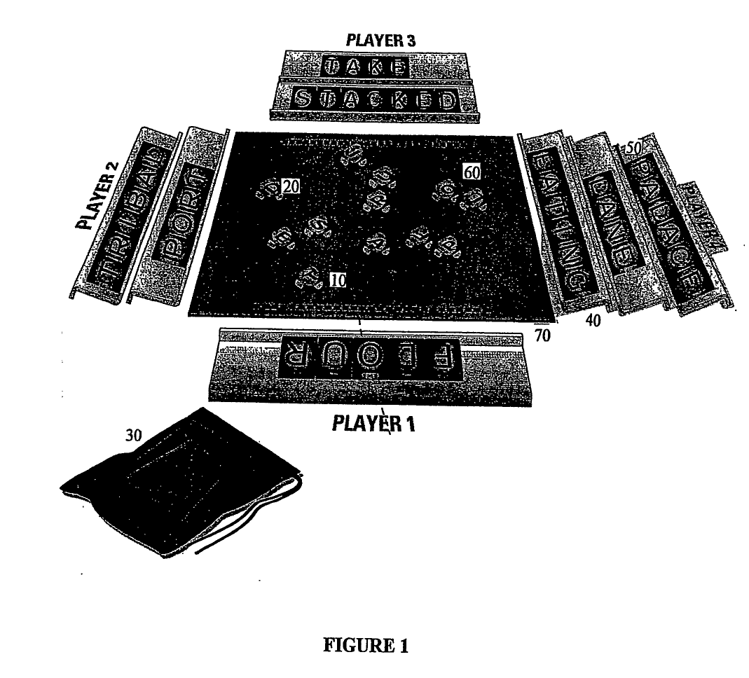

With reference to FIG. 1, one embodiment of the present invention comprises a number of playing units 10 or tiles, each of which bears an insignia 20 which can be a letter of an alphabet or a joker insignia. Playing units 10 of a square shape are shown but these units may be round, triangular, hexagonal or some other appropriate 2D or 3D shape. The total number of these playing units 10 is not critical, however the ratio of the various insignias can be determined based on the language in which the game is being played or other criteria. In one embodiment there is a single joker playing unit contained in the collection of playing units. The playing units may be supplied, for example, in a container, such as a bag 30 having a drawstring, providing a means for random selection of said playing units. Furthermore, there are playing unit display means 40, providing the ability to display the playing units, which have been formed into words 50, enabling all players to see said playing units. Finally, there exists in the view of all players an exposed collection 60 of playing units which are placed, for example, on a playing surface 70. This exposed collection 60 of playing units and the playing units of preformed words, combined, are the active playing units for the game at any given instance.

In one embodiment of the present invention the active player must form appropriate words during the game, in order for these words to be acceptable. For example, words which are not acceptable may comprise proper nouns, abbreviations and acronyms, in addition to words formed from less than a predetermined minimum number of letters, for example 3 or 4 letters.

Electronic Game Apparatus

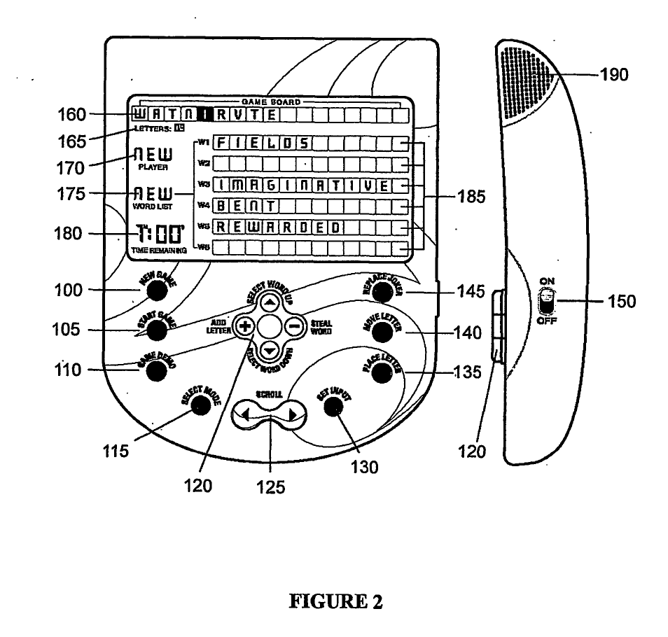

A further embodiment of the present invention enables the play of the game through the use of an electronic game apparatus. In one embodiment of the present invention, as illustrated in FIG. 2, the electronic game apparatus is a single unit which is of a size and weight such that it may be held in the hand of a player.

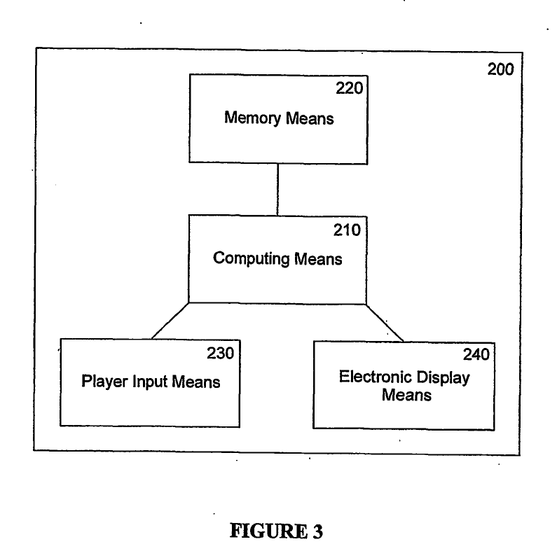

In one embodiment and with reference to FIG. 3, the electronic game apparatus 200 comprises a memory means 220, comprising an electronic dictionary compatible with a desired language, an electronic version of a set of rules for playing the word game and areas for temporary storage of information during play of the word game; a computing means 210 for performing tasks, wherein said tasks comprise selecting, randomly, one or more playing units and comparing words formed during play of the word game with words contained in the electronic dictionary thus providing a means for verifying said formed words; a player input means 230 for enabling a player to interact with the computing means during play of the word game and an electronic display means 240 comprising a plurality of areas, wherein said areas display game information to a player and may be considered the playing surface. The computing means 210, memory means 220, player input means 230 and the electronic display means 240 are in electronic communication with each other and serve a means for playing the word game.

Computing Means

The computing means performs necessary computational tasks during the play of the game and can be any computing system with capabilities for performing these tasks. These tasks comprise randomly selecting one or more playing units for including said playing units in the exposed collection, selecting the sequence in which one or more players participate in the game, verifying words which are arranged during play of the game and sequencing events during play of the game and interpreting the inputs of a player using the player input means. The computing means is in electronic communication with the memory means, player input means and the electronic display means thus providing a means for the computing means to perform tasks necessary to provide the electronic game apparatus with its functionality according to the present invention.

In one embodiment of the present invention, the physical size of the computing means may be dependent on the desired size of the electronic game device. For example, a computing means required for a hand-held apparatus may be different from a computing means required for a desktop version of the apparatus. The appropriate computing means for each particular embodiment of the electronic game apparatus would be know by a worker skilled in the art of manufacture and design of electronic game devices.

Memory Means

The memory means contains information relating to the play of the game including information which is permanent and information which is transitory, wherein the transitory information relates to events occurring during a particular game session.

In one embodiment of the present invention, the memory means comprises an electronic dictionary which may be specifically designed to incorporate only words which are allowable for the play of the game. For example, words which are not allowable may include proper nouns, abbreviations and acronyms, in addition to words which are formed from less than a predetermined minimum number of letters, for example 3 or 4 letters. In addition, the electronic dictionary can be accessed by the computing means in order that a particular word which is arranged by a player can be verified for its acceptability in relation to the game. The memory means may also comprise a letter ratio which is consistent with the language in which the game is being played, wherein this letter ratio may provide the computing means additional information during the random selection of one or more playing units.

In another embodiment, the memory means further comprises an electronic version of the set of rules or playing procedure relating to the procedure required for the playing of the game. The computing means may access this set of rules in order to determine the sequence in which the game is to be played and therefore may assist in the direction of the play of a particular player.

In another embodiment, the memory means comprises a plurality of instructions relating to the functionality of the player input means including a button activation sequence required to result in a desired activity, for example letter selection. These instructions enable the computing means to interpret a player's desired task based on the activation of a particular button contained within the player input means. In addition, instructions may be provided enabling the computing means to control the information which is displayed to the player using the electronic display means.

In one embodiment, the memory means further comprises areas for temporary storage of information during the play of a particular word game. This enables a player to remain updated as to the tasks which have been performed by the computing means and any player which has interacted with the electronic game apparatus. The information contained within this temporary storage area may be purged or deleted upon the completion of a particular game and therefore provide storage space for information relating to the play of a subsequent game session.

Player Input Means

The player input means enables the player to interact with the electronic game apparatus in order to play the game. In one embodiment of the present invention, the player input means is a plurality of buttons, wherein these buttons may provide one input parameter or a plurality of input parameters to the game apparatus during play of the game.

In one embodiment of the present invention and with reference to FIG. 2, a button may provide a means for starting a new game 100, or replacing a joker letter 145 or placing a letter 135. In addition there may be multifunction buttons which enable a plurality of functions to be performed by manipulating this type of button, for example the cross button 120 provides a means for moving a cursor located on the electronic display means up and down a word list in addition to adding a letter and stealing a word.

In a further embodiment of the present invention, the player input means may have the ability to be illuminated or light-emitting. This feature may be activated and one or more buttons may commence flashing when said one or more buttons become the subsequent button(s) to be activated during a sequence of events. This provides a means for prompting the active player for input information and further enables the player to learn the sequence of events necessary to play the game. In one embodiment of the invention, this feature may be incorporated with a game demo feature enabling a player to learn the functionality of the electronic game apparatus and thus may improve the ease with which to learn and play the game.

Electronic Display Means

The electronic display means or playing surface displays information relating to the game being played to the one or more players. The electronic display means comprises a plurality of areas, wherein particular information is displayed in each area The electronic display means can be a LCD (liquid crystal display) or a LED (light emitting diode) display or any other type of display which would be compatible with the electronic game apparatus, as would be known to a worker skilled in the art.

In one embodiment of the present invention and with further reference to FIG. 2, the electronic display means can be configured as illustrated. The electronic display means comprises areas for display of the exposed collection 160, the active player 170, a word list 185, the owner of said word list 175 and the time remaining 180 in a particular word forming session, if selected. Each of these display areas enables the active player to evaluate the opportunities for word creation during play of the game. In one embodiment of the invention, each area of the electronic display means may be accessed by the use of a select mode button 115 and may be traversed using a scroll button 125 for example, wherein said buttons can be incorporated into the player input means.

In one embodiment of the present invention, the players input their names into the electronic game apparatus and the electronic game apparatus uses this information in order to define the active player 170 and the owner of the word list 175 areas which are identified using the electronic display means. In one example a player may be limited to the number of letters with which to identify themselves.

In one embodiment, the electronic display means incorporates a cursor, wherein the position of said cursor can be defined by inverting the lighting conditions at the position of the cursor, wherein light becomes dark and vice versa or the information contained at the cursor position begins flashing. This type of identification feature associated with the cursor position may enable a player to locate the cursor on the electronic display means in rapid manner and may provide a player with the means to select desired playing units or words during play of the game.

In one embodiment of the present invention, the electronic game apparatus may comprise a speaker system which enables the electronic game apparatus to produce various types of sound indicating the occurrence of a particular event, for example the completion of a turn or the arrangement of an invalid word. This sound may be a particular pitch or sequence of pitches or may be a special phase produced by the speaker system.

In a further embodiment, the electronic game apparatus may be configured such that players in multiple locations (local or global) may participate in a particular game according to the present invention via a computing network for example. The computing network may be a local area network or a global network for example the Internet. A worker skilled in the art would understand the technological requirements in order to facilitate the functionality of this form of the present invention.

One of ordinary skill in the art would know how to design and assemble the above hardware and to design and provide the required software for the operation of the electronic word game according to the present invention as hereindescribed.

In one embodiment of the present invention, a typical set of game rules is described is below using a board game apparatus. It would be obvious to a worker skilled in the art of electronic game manufacture, as to the procedure for the incorporation of the following defined set of rules or game rules, into an electronic game apparatus format.

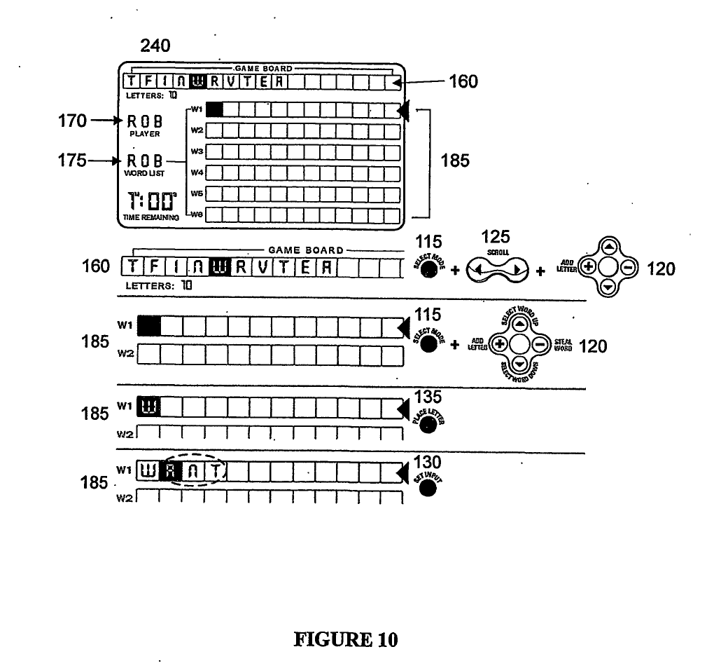

An example of the procedure for play of the game using an electronic gaming device is described in Example 2 and illustrated in FIGS. 10-14.

Standard Method of Play

Set-up.

In one embodiment of the present invention, all playing units are placed in a container providing random playing unit selection and a predetermined number of these playing units are selected and placed on the playing surface exposing the insignia thereon, thereby forming the initial exposed collection. Each player subsequently selects one playing unit, wherein the player selecting the letter “A” or the letter closest to the letter “A” in the alphabet, commences the game. The order of play proceeds in for example, a clockwise manner commencing with player one, as selected previously. Each of the playing units selected by the players, as specified above, is also placed in the exposed collection and thus provides the playing units to commence the game. Each player subsequently selects a further playing unit from the container and conceals its value from the rest of the players.

Playing the Game

Player one places their concealed playing unit in the exposed collection and attempts to construct a word of at least three letters using the playing units located within said exposed collection. This player can make as many words as possible using the exposed playing units. Each word constructed is placed in front of the player, indicating the owner of the word. These formed words can be placed, for example, on a playing unit display means allowing all players the ability to view the word. Once a word is constructed, the active player draws a playing unit from the container and attempts to form another word. A player's turn is over once no further words can be made. Optionally a timer can be used to limit the time allowed for the construction of a word. Upon completion of the turn, the player draws a playing unit from the bag, without allowing the other players to see it and waits their next turn.

Player two then places their playing unit in the exposed collection and attempts to construct a word using the available playing units. Play continues as described above. A player is considered the winner once said player has formed and maintained possession of a predetermined number of words, for example a total of 6 words.

One aspect of the game allows for the stealing of a word previously formed by another player. If the active player can add one or more playing units to a previously formed word and create a new word by rearranging these letters, they can steal this previously formed word from an opponent. This procedure increases the word count of the active player while decreasing the word count of an opponent.

Furthermore there is provided at least one joker letter, which may be assigned the value of any letter in the alphabet being used, however the value of this playing unit can change over the course of the game. For example, if a joker letter is in play, (for example, contained in one of the pre-formed words), then the active player may steal the joker playing unit by replacing it with a playing unit which results in this pre-formed word still being a valid word. For example, replacing the joker letter contained in the word “*EAN”, wherein the “*” represents a joker insignia, with the letter “B” or “L” will result in the formation of a valid word. The joker playing unit is then added to the exposed collection and the active player may assign the joker playing unit any value and use said playing unit to construct a new word.

There are several methods of use of a joker playing unit during the game, as shown by the following: 1) A player can steal the entire word containing the joker playing unit from an opponent by adding at least one playing unit and rearranging these playing units to form a new word (e.g. the playing units in the pre-formed word and the additional tile). The value of the joker playing unit can be changed to create this new word; 2) One can replace the joker playing unit in a pre-formed word with a letter playing unit from the exposed collection enabling the formation of a valid word as previously described. This joker playing unit in conjunction with playing units from the exposed collection and/or pre-formed words can be used to form a new word; and 3) The active player can replace the joker playing unit with any playing unit from the exposed collection and rearrange the playing units of the pre-formed word including the new playing unit, but excluding the joker playing unit, to create a new word. This joker playing unit, in conjunction with playing units from the exposed collection and/or pre-formed words can be used to form a new word.

In one embodiment of the present invention play can continue in a particular direction around the playing surface, for example clockwise or anticlockwise or for example the order of play may be randomly assigned at the beginning of the game.

In one embodiment of the present invention, play of the game proceeds as described above until no further words can be arranged using the exposed collection and/or the pre-formed words or the pool of playing units is exhausted or a predetermined number of words have been assigned to the possession of a particular player. Subsequently the player having possession of the largest number of formed words is declared the winner.

In a further embodiment, a letter which is associated with a particular playing unit may be assigned a particular value. In this scenario, upon the completion of the game in a manner as previously described, the players may subsequently determined a point total, for example, by adding up the value of the plurality of letters within the words to which they claim ownership, wherein the winner has the highest point total, for example.

In one embodiment of the present invention, in order to maintain fluidity of the game, the possibility of time limits for the formation of words is possible. For example, a limit of one minute, two minutes or three minutes per word formation attempt may be suitable. The game becomes more difficult if the time limit is reduced and conversely the game is easier if the time limit is increased. In one embodiment of the present invention, there are no pre-assigned time limits.

In a further embodiment, restrictions may also be placed on allowable words, for example, words less than 3 letters, proper nouns, abbreviations and acronyms may not be accepted. It may be useful, however, for a dictionary to be consulted in order to verify the legitimacy of a particular word, if it is so required.

As it would be appreciated by a worker skilled in the art, there is a plurality of strategies which may be used during the course of play of this game. For example, the formation of longer words increases the difficulty for an opponent to steal said word and thus may be considered a defensive strategy. In addition, constantly attempting to steal the words of an opponent, thus decreasing their word count may be considered an offensive strategy.

### EXAMPLES

### Example 1

### Board Game Apparatus

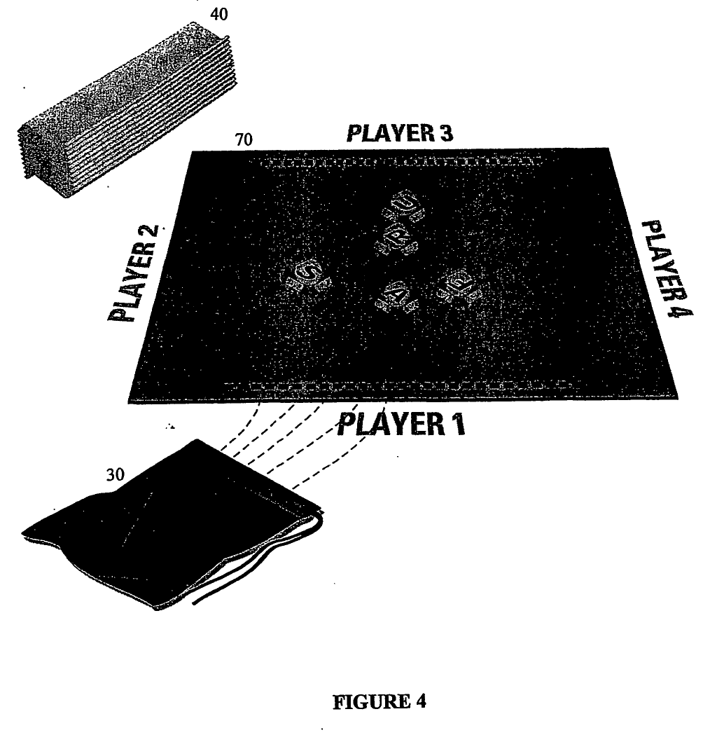

In one embodiment of the present invention an example of the sequence of playing the game using a board game apparatus is illustrated in FIGS. 4-9.

Referring to FIG. 4, the initial setup of the game requires the placement a playing surface 70 in a position allowing a full view of said board by all players. Also placed in the playing area is a container 30, which contains a plurality of playing units with letters or emblems imprinted thereon and a plurality of playing unit display means 40. A predetermined number of random playing units are selected from a container 30 or bag which contains the plurality of playing units, and these playing units are placed on the game board 70 exposing the letter or joker emblem that is imprinted thereon.

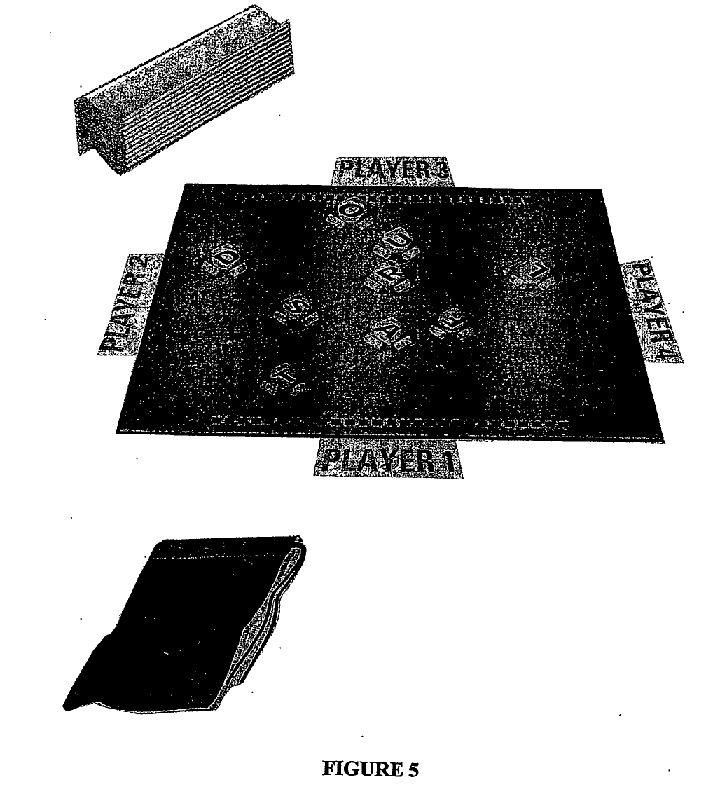

With reference to FIG. 5, each player randomly draws a playing unit from the remaining plurality of playing units in the container and places it on the board exposing the letter or “joker” emblem that is imprinted thereon. The player selecting an “A” or the letter closest to an “A” in the alphabet, plays first. If there is a tie, a further playing unit is selected by the tied players, with this continuing until a starting player is selected. In FIG. 5, for example, players 1, 2, 3 and 4, selected a “T”, “D”, “O” and a “L”, respectively. In this example player 2 would commence the game and play would proceed in a clockwise direction. These selected playing units along with the playing units previously selected, form the exposed collection, which will be located on the playing surface 70 and provide the basis for the commencement of the game. For the purpose of the remainder of this example, it is assumed that player 1 is the active player.

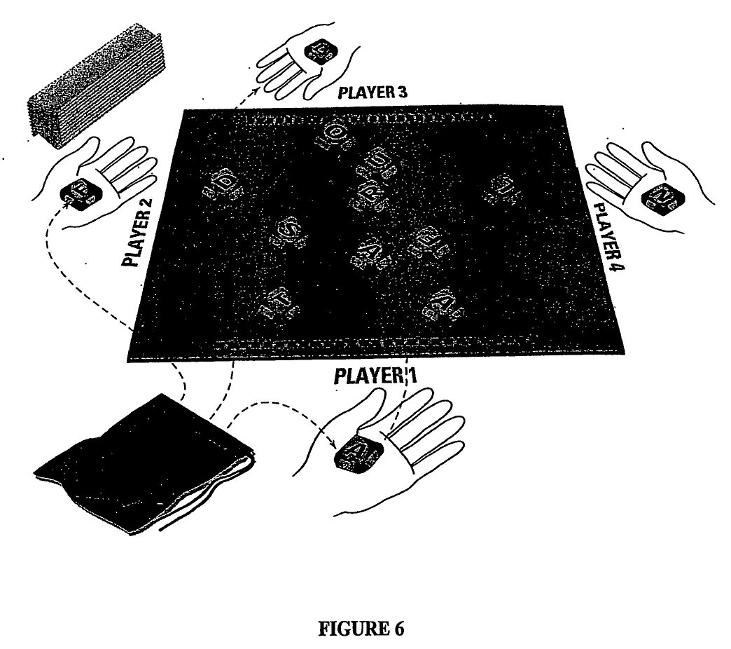

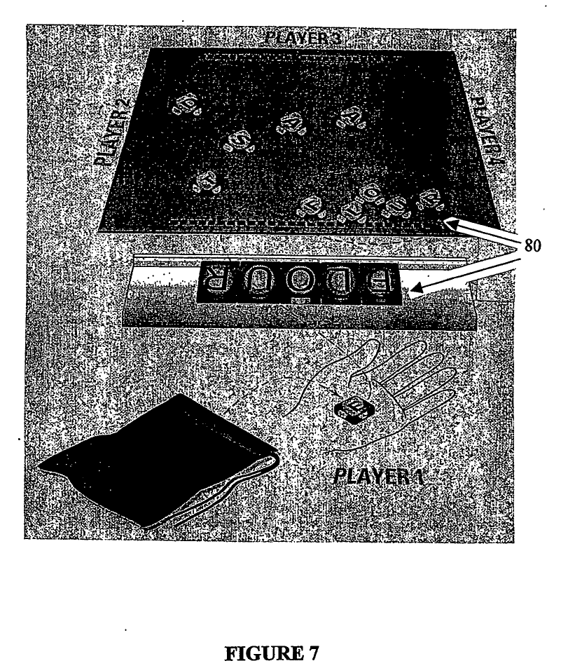

With reference to FIG. 6, each player further randomly selects one playing unit from the plurality of remaining playing units and conceals said playing unit from view of the other players. Player 1 exposes their playing unit and includes it in the exposed collection and attempts to form a word with said exposed collection. For example, with reference to FIG. 7, player one can form the word “FLOUR”. Upon formation of this word, player 1 removes the playing units necessary to form “FLOUR” and places them on a playing unit display means in-front of them 80, allowing all players to view the word that has been created. Upon creation of a word and extraction of the required playing units, player 1 can randomly select another playing unit from the remaining plurality of playing units, placing said playing unit in the exposed collection and attempt to form further word. This will continue until player 1 is unable to create another word, either using the playing units within the exposed collection and/or by stealing of an opponents word, as described below or the letter pool is exhausted or the completion of a predetermined time limit. Once turn of player 1 is concluded, they select another playing unit from the remaining plurality of playing units and wait for their next turn.

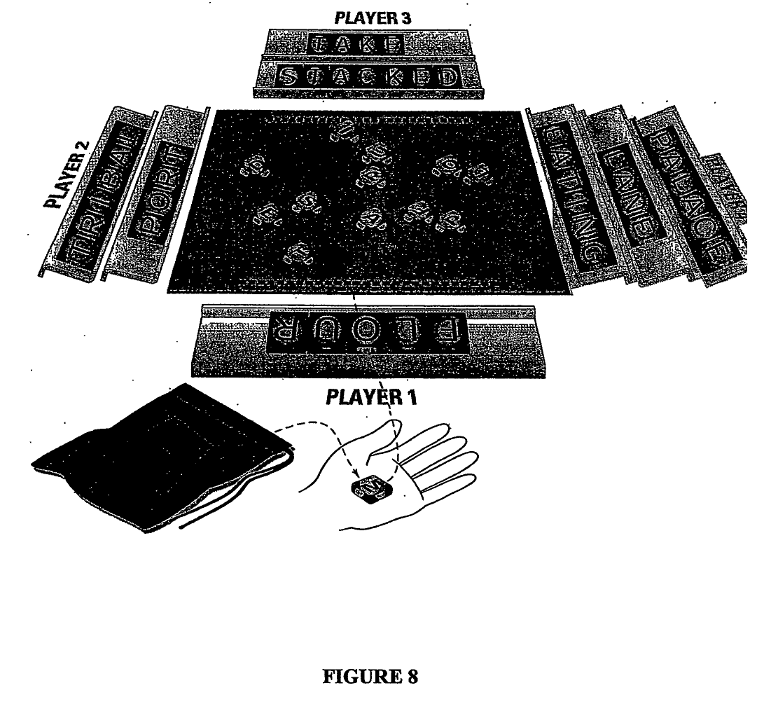

FIG. 8 illustrates the procedure for the stealing of an opponent's word. In order for the active player to steal a word from an opponent, the active player must add at least one letter to the preformed word and rearrange all of these letters to make a new word. For example, player 1 places an “M” into the exposed collection. By adding an “M”, “T” and “R” to the word “LANE” in the current possession of player 4, and rearranging all of said letters to form the word “MNERAL” and placing said word on a playing unit display means in front of themselves, player 1 takes possession of the new word.

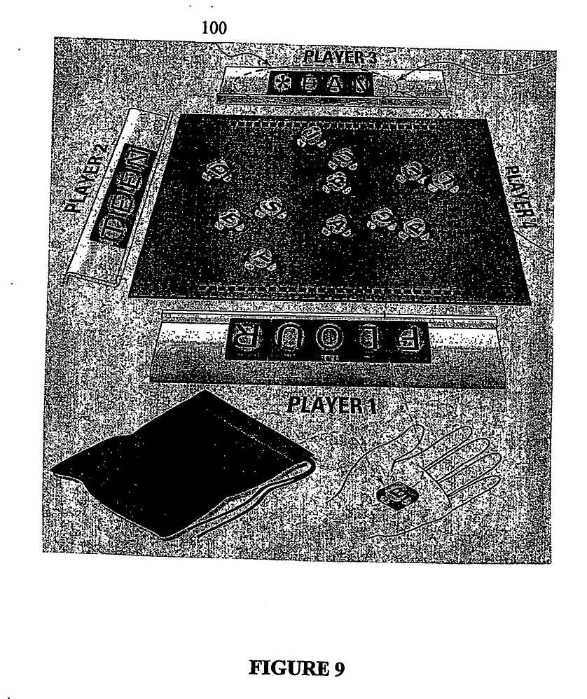

With reference to FIG. 9, possible uses of the joker playing unit 100 will be illustrated. Player 3 has possession of the joker playing unit 100 with a value of “B” resulting in the word “BEAN”. 1) Player 1 is able to steal this word from player 3 by adding the letter “G”, changing the value of the joker playing unit 100 from “B” to “L” and rearranging these letters to form the word “ANGEL”. 2) Player 1 could take just the joker playing unit 100 from player 3, by replacing said playing unit with the letter “B” from the exposed collection. Player 1 may proceed to steal the word “TEEN” which is in the possession of player 2, by adding the letters “B” and “E” and changing the value of the joker playing unit 100 to “W”, proceeding to rearrange said playing units forming the word “BETWEEN”. Player 1 would subsequently randomly select a playing unit from the remaining plurality of playing units and continue to attempt to form new words. 3) Player 1 can also just take the joker playing unit 100 from player 3 by replacing said playing unit with the letter “T”, and rearranging the four letters to form the word “ANTE”. Player 1 may proceed to use the letter “S”, “R”, “U” and “B” contained in the exposed collection, including the joker playing unit 100 with its value changed to “H”, to form the word “SHRUB”. Player 1 would select a playing unit from the remaining plurality of tiles and continue to attempt to form new words. It should be noted that if at least one letter is not added to a word containing the joker playing unit 100, the stealing of said word is not possible, thus the ownership of said word does not change.

The game will proceed in a similar fashion as stated above until all players are unable to form new words or a particular player has formed and maintained possession of a predetermined number of words or the pool of playing units is exhausted. The active player will change sequentially, in the manner determined at the commencement of play.

### Example 2

### Electronic Game Apparatus

In one embodiment of the present invention an example of the sequence of playing the game using an electronic game apparatus is illustrated in FIGS. 10-14. These figures illustrate the functionality of the electronic game apparatus through a series of procedures including the formation of a word from the exposed collection, the formation of a word through the stealing of a preformed word and methods of obtaining and using a joker playing unit. A worker skilled in the art would understand how to modify the sequence of events described below in order to facilitate the desired outcome using an electronic apparatus and this variation should be considered within the scope of the present invention.

With reference to FIGS. 2 and 10, a sequence of events for the formation of a new word using letters contained within the exposed collection is illustrated. Upon examination of the playing units contained in the exposed collection 160, the creation of the word “WANT” is selected by the active player. The active player actuates the select mode button 115 until the cursor is located within the exposed collection 160. The active player subsequently operates of the scroll button 125 in order to translate the cursor to the position assigned to the letter “W” at which point the active player activates the add letter action provided by the cross button 120. The active player proceeds to activate the select mode button 115 to move the cursor to a word list 185 and subsequently activating the select word action (up or down) provided by the cross button 120 in order to select the word field. By actuating the place letter button 135 the letter “W” will be placed in the desired word field. These steps are subsequently repeated in order to relocate the letters, “A”, “N” and “T” into the letter field thus forming the word “WANT”. Upon completion of this procedure the active payer actuates the set input button 130 to set this word in the word list attributed to the active player.

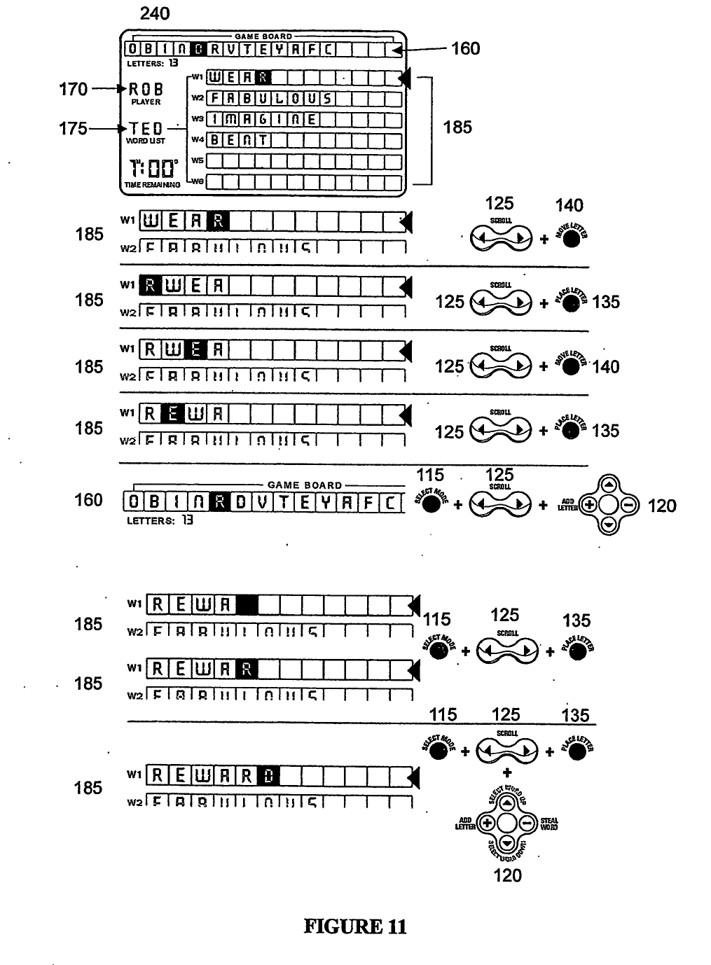

With reference to FIGS. 2 and 11, a sequence of events for the stealing of a preformed word is illustrated. The active player identifies the word “WEAR” in the word list of Ted and furthermore identifies the letters “R” and “D” in the exposed collection 160. Therefore by rearranging the word “WEAR” and adding the letters “R” and “D” a new word “REWARD” can be formed thus providing a means for the active player to steal the word “WEAR” from Ted and take ownership of the new word “REWARD”. One sequence of events for the execution of this procedure is illustrated in FIG. 11. Initially the active player activates the select mode button 115 and the scroll button 125 until the owner of the word list 175 is identified as Ted and the active player selects the word “WEAR” using the cross button 120. The active player rearranges the word “WEAR” to “REWA” using the scroll button 125, move letter button 140 and the place letter button 135 in a sequence as illustrated. The active player subsequently activates the select mode button 115 to transfer the cursor to the exposed collection 160, actuating the scroll button 125 until the cursor is at the location of the letter “R” and then activates the add letter action provided by the cross button 120. The active player then activates the select mode button 115 to return to the word list of Ted and subsequently uses the scroll button 125 to reach the desired position of the letter “R” and then depresses the place letter button 135. This sequence is repeated in order to transfer the letter “D” from the exposed collection to the new word “REWARD”. Upon completion of the new word the player activates the steal word action provided by the cross button 120 which instructs the computing means to delete the word “WEAR” from the word list of Ted and insert the word “REWARD” into the active player's word list (Rob). This act reduces an opponents word count and increases the active player's word count.

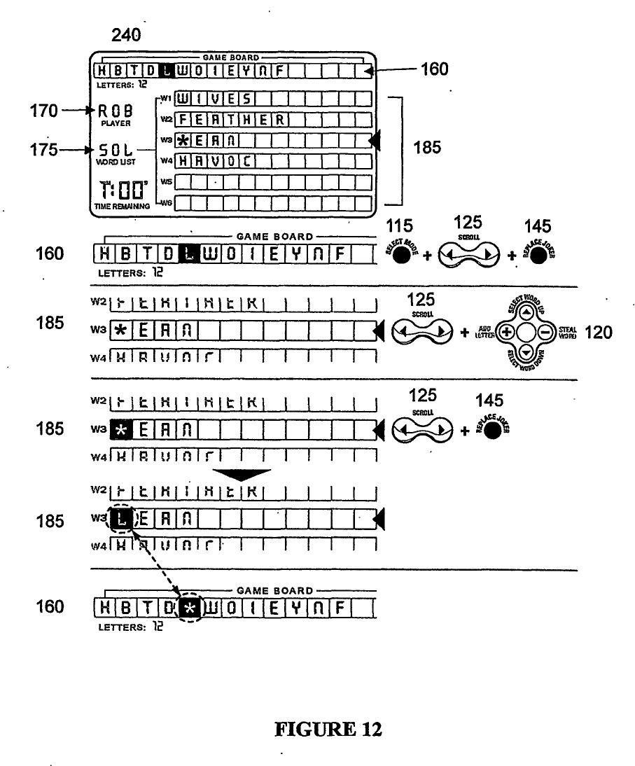

With reference to FIGS. 2 and 12, a sequence of events for the replacement of a joker playing unit contained in a pre-formed word is illustrated. FIG. 12 illustrates the process of the direct replacement of a joker playing unit contained in a pre-formed word with a playing unit from the exposed collection. For the purpose of illustration the joker playing unit is indicated by a “*”. The active player identifies the word “*EAN” in an opponent's word list and further identifies the letter “L” in the exposed collection and thus desires to replace the joker playing unit with the letter “L” to form the word “LEAN”. As previously illustrated the active player moves the cursor until the letter “L” is selected and subsequently activates the replace joker button 145. The active player proceeds to the word “*EAN” and selects the “*” and subsequently activates the replace joker button 145 again. This procedure replaces the “*” in the word “*EAN” with the letter “L” thus forming the word “LEAN” and subsequently places the joker playing unit into the exposed collection 160 for subsequent use by the active player.

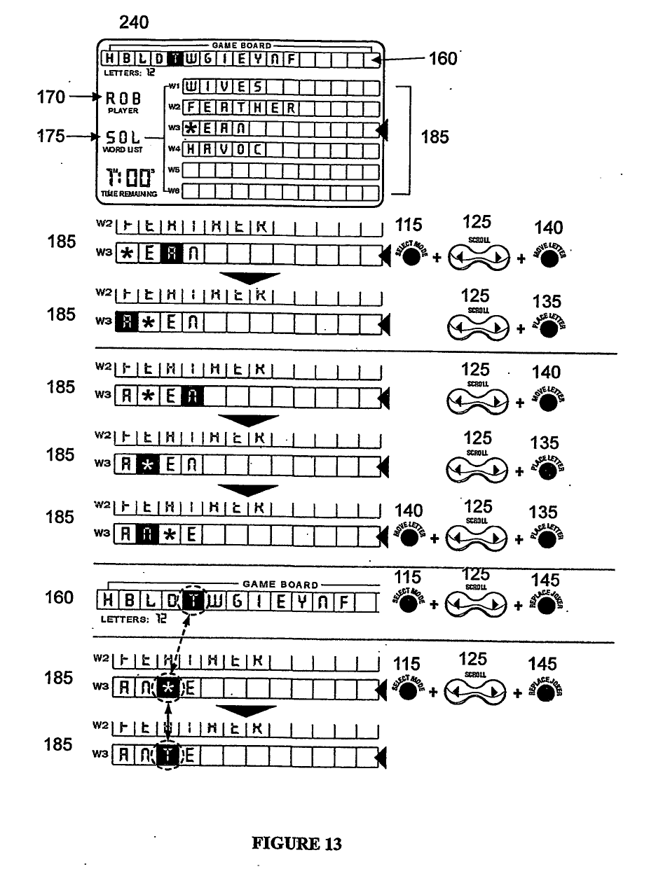

With reference to FIGS. 2 and 13, an alternate sequence of events for the replacement of a joker letter contained in a pre-formed word is illustrated. The active player identifies the word “*EAN” in an opponent's word list and further identifies the letter “T” in the exposed collection. The active player can replace the joker playing unit with the letter “T” and rearrange the letters of this word such that the word “ANTE” is formed. Using a sequence of button activation as previously described the active player accesses the word “*EAN” and rearranges the letters such that the word “AN*E” is formed. The player subsequently proceeds with the above method of replacing the joker playing unit with the letter “T”. The letter “T” is then removed from the exposed collection and the joker playing unit is placed in exposed collection for subsequent use by the active player.

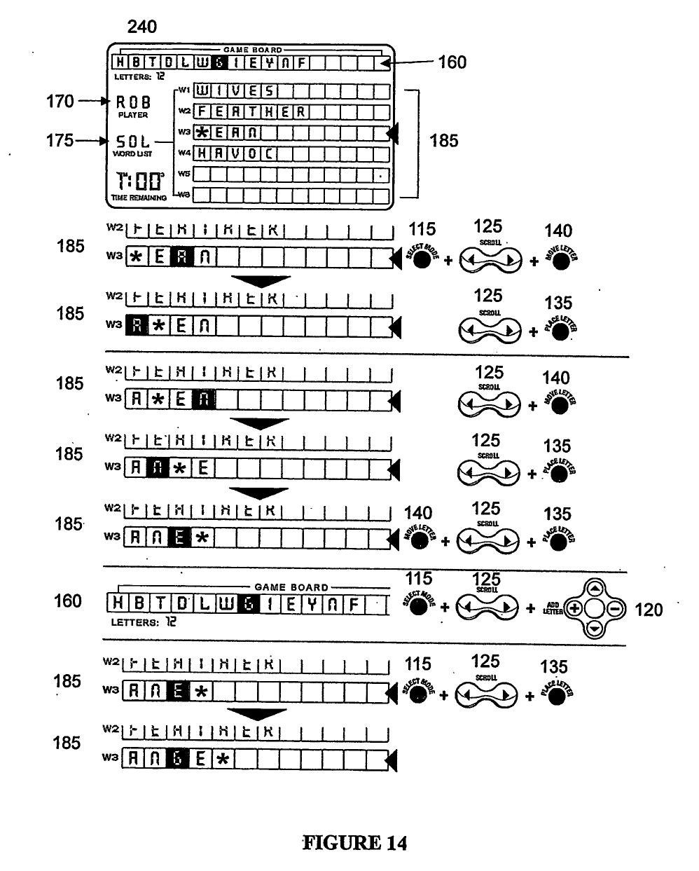

FIG. 14 illustrates an example of a sequence of events necessary to steal an opponent's word which comprises the joker playing unit. This sequence of events is parallel to those previously described in relation to FIG. 11. In addition, the computing means may assign any letter value to a joker playing unit which enables the formation of an acceptable word wherein said acceptable word is contained in the electronic dictionary which is stored in the memory means of the electronic game apparatus, for example.

The above described sequence of events necessary to produce the desired affect are according to one embodiment of the present invention and said invention should not be limited to these particular sequence of events.

### Example 3

### Play of the Word Game Over a Network

In one embodiment, an electronic game apparatus may be configured for the play of the word game according to the present invention by a plurality of players, wherein the players are remotely located with respect to each other. In this embodiment, the electronic game apparatus may comprise primarily software which can be installed on computing devices being used by each participating player and said computing devices may be interconnected using a network, for example, a hardwired or wireless LAN (local area network) or a global network, for example, the Internet. A worker skilled in the art of electronic game design and manufacture would understand the procedures for the generation of the software and integration of said software into the hardware in order to create a system providing a means for playing the word game according to the present invention in a virtual manner.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

I claim:

1. An electronic word game apparatus comprising:
a) a memory means comprising:
i) an electronic dictionary compatible with a desired language;
ii) an electronic version of a set of rules for playing the word game; and
iii) areas for temporary storage of information during play of the word game;
b) a computing means for performing tasks, wherein said tasks comprise:
i) selecting, randomly, one or more letters;
ii) comparing words formed during play of the word game, with words contained in the electronic dictionary providing a means for verification of formed words;
c) a player input means for enabling a player to interact with the computing means during play of the word game; and
d) an electronic display means comprising a plurality of areas, wherein said areas display game information to a player;
wherein said computing means, memory means, player input means and electronic display means are in electronic communication with one another and serve for playing said word game according to the set of rules comprising:
(1) selecting, randomly, a predetermined number of starting letters selected from a pool of letters and exposing said starting letters to form an exposed collection, wherein said pool of letters comprises letters of an alphabet and at least one joker letter, wherein said joker letter can be assigned a value of any letter within the alphabet and wherein said value of the joker letter can be amended during play;
(2) arranging a new word having an assigned minimum number of letters by:
i) using letters contained within said exposed collection; or
ii) stealing a word previously arranged by another player, wherein the new word is formed by the arrangement of a group of letters comprising the letters of the stolen word and at least one letter from the exposed collection;
wherein said arranging is performed by an active player and wherein upon formation of the new word the active player is assigned ownership of the new word and wherein upon the occurrence of a predetermined event a subsequent player becomes the active player; and
(3) continuing with step (2) until a player has been assigned ownership of a pre-selected number of formed words or the pool of letters is exhausted or no further words are capable of being formed;
and wherein a letter randomly selected from the pool of letters is exposed and added to the exposed collection prior to the arranging of a new word by the active player.

2. The use of the electronic word game apparatus according to claim 1 as an educational tool.

3. The electronic word game apparatus according to claim 1 wherein said joker letter can be removed from a previously formed word comprising said joker letter provided said joker letter is replaced with a replacement letter from the exposed collection and said replacement letter provides a means for forming a word by direct replacement of said joker letter or by arrangement of a group of letters comprising the replacement letter and the letters of the previously formed word, excluding the joker letter.

4. The electronic word game apparatus according to claim 1, wherein said predetermined event is selected from the group comprising: an inability to form a new word or completion of a particular time interval.

5. The electronic word game apparatus according to claim 1, wherein said alphabet is consistent with a language selected from the group comprising: English, French, Spanish, Portuguese, German, Arabic, Greek, Chinese and Japanese.

6. The electronic word game apparatus according to claim 5, wherein said pool of letters has a letter ratio compatible with a letter frequency of the language in which the word game is to be played.

7. A word game comprising the steps of:
a) providing a game apparatus to a group of one or more players;
b) selecting, randomly, a predetermined number of starting letters selected from a pool of letters and exposing said starting letters to form an exposed collection, wherein said pool of letters comprises letters of an alphabet and at least one joker letter, wherein said joker letter can be assigned a value of any letter within the alphabet and wherein said value of the joker letter can be amended during play;
c) determining, randomly, which player is to be designated an active player;
d) selecting, randomly, a particular number of letters from the pool of letters, subsequently exposing and adding these letters to said exposed collection;
e) arranging a new word having an assigned minimum number of letters wherein said letters are selected from said exposed collection and wherein said arranging is performed by the active player, wherein upon formation of a new word the active player is assigned ownership of the new word;
f) continuing with step (e) until a predetermined event, wherein upon the occurrence of said predetermined event a subsequent player becomes the active player:
g) arranging a further new word having an assigned minimum number of letters by:
i) using letters contained within said exposed collection; or
ii) stealing a word previously arranged by another player, wherein the new word is formed by the arrangement of a group of letters comprising the letters of the stolen word and at least one letter from the exposed collection;
wherein said arranging is performed by the active player and wherein upon formation of the new word the active player is assigned ownership of the new word and wherein upon the occurrence of the predetermined event a subsequent player becomes the active player;
h) continuing with step (g) until a player has been assigned ownership of a pre-selected number of formed words or said pool of letters is exhausted or no further words are capable of being formed;
i) determining a winner by evaluating which player is assigned ownership of the largest number of words;
wherein a letter randomly selected from the pool of letters is exposed and added to the exposed collection prior to the arranging of a new word by the active player.

8. The word game according to claim 7 wherein said joker letter can be removed from a previously formed word comprising said joker letter provided said joker letter is replaced with a replacement letter from the exposed collection and said replacement letter provides a means for forming a word by direct replacement of said joker letter or by arrangement of a group of letters comprising the replacement letter and the letters of the previously formed word, excluding the joker letter.

9. The word game according to claim 7, wherein said predetermined event is selected from the group comprising: an inability to form a new word or completion of a particular time interval.

10. The word game according to claim 7, wherein said alphabet is consistent with a language selected from the group comprising: English, French, Spanish, Portuguese, German, Arabic, Greek, Chinese and Japanese.

11. The word game according to claim 10, wherein said pool of letters has a letter ratio compatible with a letter frequency of the language in which the word game is to be played.
